(19) United States
(12) Patent Application Publication
(10) Pub. No.: US 2017/0102134 A1
(43) Pub. Date: Apr. 13, 2017

(54) Tensile Resistant Light String

(71) Applicant: POLESTAR ELECTRIC INDUSTRIES CO., LTD., Jiangmen City (CN)

(72) Inventors: Cheng-Tao Chang, Hsinchu City (TW); Chu-Cheng Chang, Hsinchu City (TW); Cheng-Fen Chang, Hsinchu City (TW)

(21) Appl. No.: 14/957,796

(22) Filed: Dec. 3, 2015

(30) Foreign Application Priority Data
Oct. 13, 2015 (CN) 201520790162.X

(51) Int. Cl. F21V 23/00; F21V 23/06; H01B 1/02; H01B 7/04; F21S 4/10; H01B 3/30

(52) U.S. Cl. CPC F21V 23/001; F21S 4/10; H01B 3/30; H01B 1/02; H01B 7/04; F21V 23/06

(57) ABSTRACT

The present invention provides a tensile resistant light string comprising: multiple illuminating units electrically connected by multiple wires, wherein each one of the wires comprising: a tensile resistant layer; a conductive layer wrapping the tensile resistant layer, and an insulating layer wrapping the conductive layer; and wherein the insulating layer is made of cotton fiber, the conductive layer is consisting of multiple metal lines, the metal lines are made of copper, the tensile resistant layer is consisting of at least one line. The tensile resistance of the wires is enhanced by the tensile resistant layer.

### CROSS-REFERENCE TO RELATED APPLICATIONS

This application is based upon and claims priority under 35 U.S.C. 119(a) from China Patent Application No. 201520790162.X filed on Oct. 13, 2015, which is hereby specifically incorporated herein by this referenced thereto.

### BACKGROUND

1. Technical Field

The present invention relates to a decorative illuminating device, especially to a light string.

2. Description of the Prior Art(s)

A conventional decorative illuminating device, hung up on a tree or other objects to form a beautiful decoration, is consisted of a regular wire and multiple illuminating units connected by the regular wire. However, as the number of the illuminating units increases, the regular wire cannot afford the total weight of the illuminating units. To overcome this problem, a decorative illuminating device with assistant line is developed. An assistant line without electric conductive function is entwined with the regular wire to enhance the tensile resistance of the regular wire; therefore, the regular wire entwined with the assistant line can afford the total weight of the illuminating units.

However, using the assistant line greatly increases the cost and complicates the manufacturing process of the decorative illuminating device with assistant line. Besides, the total weight of the decorative illuminating device with assistant line is also greatly increased, which limits the application and usage of the decorative illuminating device with assistant line.

### SUMMARY

Embodiments of the invention attempt to modify the structure of the regular wire to improve the tensile resistance of the regular wire.

The present invention provides a tensile resistant light string comprising: multiple illuminating units electrically connected by multiple wires, wherein each one of the wires comprising: a tensile resistant layer; a conductive layer wrapping the tensile resistant layer, and an insulating layer wrapping the conductive layer; and wherein the insulating layer is made of cotton fiber, the conductive layer is consisting of multiple metal lines, the metal lines are made of copper, the tensile resistant layer is consisting of at least one line.

The tensile resistance of the wires of the tensile resistant light string is enhanced by the tensile resistant layer in the premise without greatly increasing the cost and the total weight of the tensile resistant light string. This broadens applications of the tensile resistant light string applicable.

Preferably, the illuminating units comprise a holder and a bulb, the bulb has two leads inserted through the holder.

Preferably, the illuminating units are light emitting diodes or incandescent lamps.

Preferably, the illuminating units comprise a receiving portion, and a hook, and then the hook is inserted into the receiving portion to fasten.

Preferably, the tensile resistant light string comprises a plug; the plug is electrically connected to the wires.

Preferably, the illuminating units are electrically connected by the wires in series, in parallel, or in parallel series.

Other objectives, advantages and novel features of the invention will become more apparent from the following detailed description when taken in conjunction with the accompanying drawings.

### BRIEF DESCRIPTION OF THE DRAWINGS

FIG. 1 is a schematic side view of a tensile resistant light string of the present invention;

FIG. 2 is a schematic enlarged side view of an illuminating unit and two wires of the tensile resistant light string of the present invention;

FIG. 3 is an explosive view of FIG. 2;

FIG. 4 is a cross-sectional schematic view across line A-A of a wire of the tensile resistant light string of the present invention.

### DETAILED DESCRIPTION

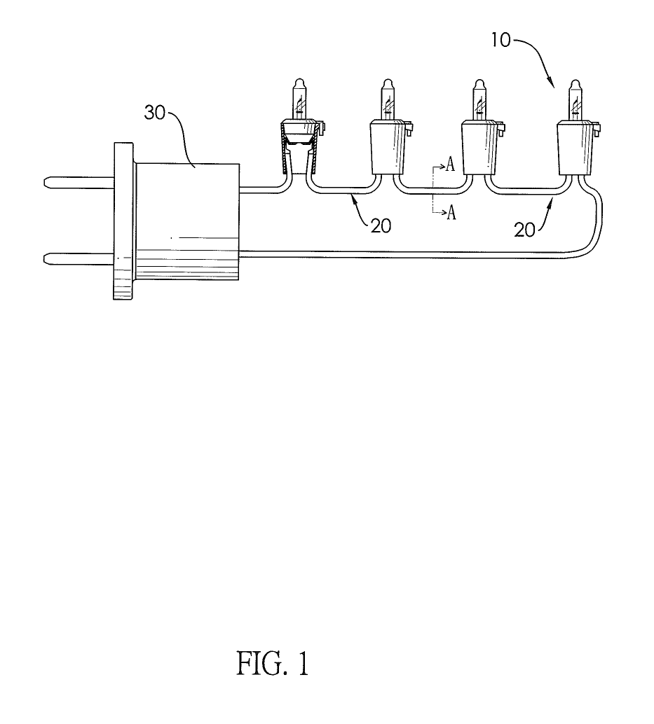

With reference to FIG. 1, the tensile resistant light string in accordance with the present invention comprises multiple illuminating units 10, multiple wires 20, and a plug 30.

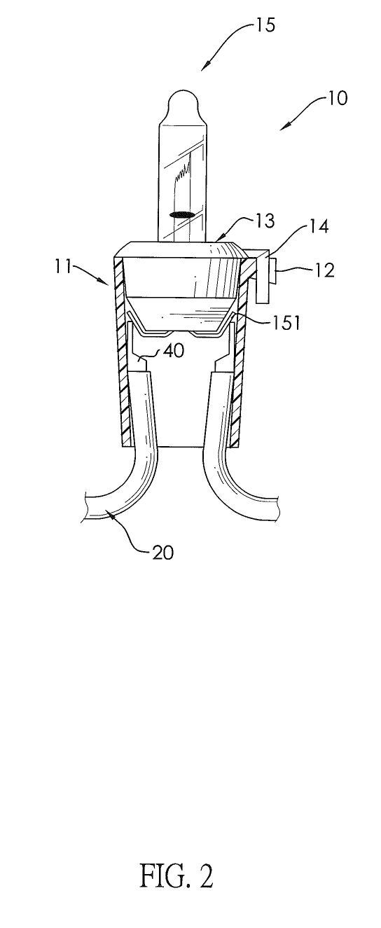

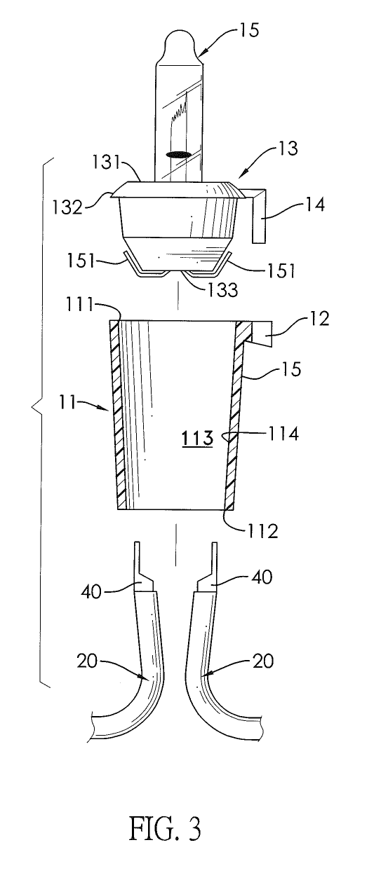

With reference to FIG. 2 and FIG. 3, each one of the illuminating units 10 is an incandescent lamp and comprises a cover 11, a receiving portion 12, a holder 13, a hook 14, and a bulb 15.

The cover 11 has a top opening 111, a bottom opening 112, a space 113, an inner wall 114, and an outer wall 115. The top opening 111 is located at the top of the cover 11. The bottom opening 112 is opposite the top opening 111 and is located at the bottom of the cover 11. The space 113 is located within the cover 11 and communicates with the top opening 111 and the bottom opening 112. The inner wall 114 is opposite the outer wall 115. The inner wall 114 is faced to the space 113.

The receiving portion 12 is mounted on the outer wall 115 of the cover 11 and is next to the top opening 111.

The holder 13 is mounted in the space 113 of the cover 11 through the top opening 111 of the cover 11 and the top opening 111 of the cover 11 is covered by the holder 13. The holder 13 has a top surface 131, a side surface 132, a bottom surface 133 and two holes (not shown in Figures). The top surface 131 is opposite the bottom surface 133. The side surface 133 is located between the top surface 131 and the bottom surface 133 and is connected to the top surface 131 and the bottom surface 133. The holes are formed through the holder 13 to form four openings on the top surface 131 and the bottom surface 133. Two of the four openings are located on the top surface 131 and the other two openings are located on the bottom surface 133.

The hook 14 is mounted on the side surface 132 of the holder 13 and is next to the top surface 131. The hook 14 is inserted into the receiving portion 12 to strengthen the combination of the cover 11 and the holder 13.

The bulb 15 is mounted on the top surface 131 of the holder 13. The bulb 15 has two leads 151. The leads 151 are inserted through the holes from the top surface 131 of the holder 13 and are protruded from the bottom surface 133 of the holder 13.

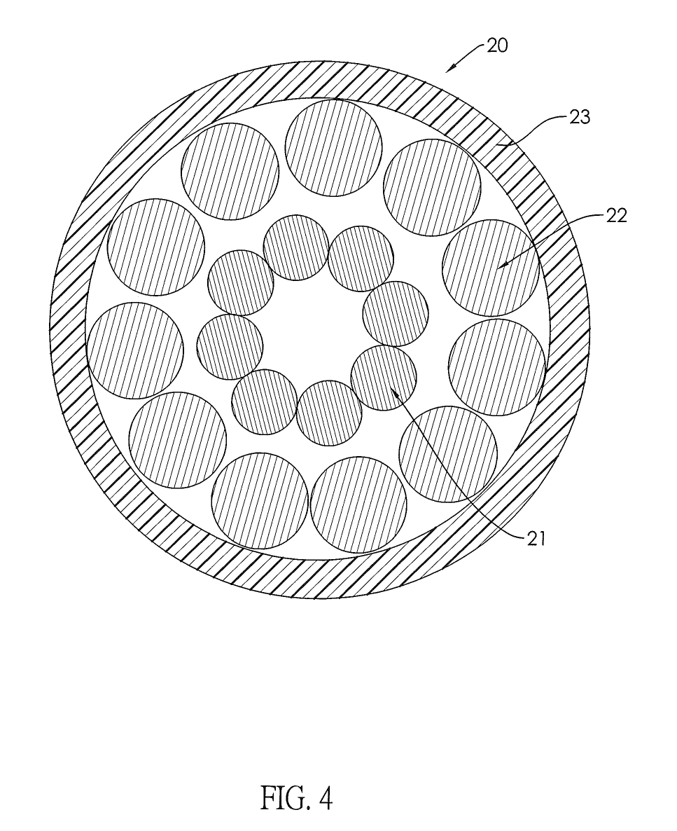

With referenced to FIG. 1 to FIG. 3, each end of each one of the wires 20 has a connecting portion 40. Each connecting portion 40 of each one of the wires 20 is connected to the corresponding lead 151 of the bulb 15. In this embodiment, the illuminating units 10 are electrically connected by the wires 20 in series. With reference to FIG. 4, each wire 20 comprises a tensile resistant layer 21, a conductive layer 22, and an insulating layer 23. The tensile resistant layer 21 is consisting of at least one line, the at least one line is a copper wire coated with a first isolation film. The first isolation film is made of plastic. The conductive layer 22 wraps the tensile resistant layer 21 and is consisting of multiple metal lines. The metal lines are made of copper. The insulating layer 23 wraps the conductive layer 22 and is made of plastic.

With reference to FIG. 1, the plug 30 is electrically connected to the wires 20.

In other embodiments, the illuminating units are electrically connected by the wires in parallel or in parallel series.

The tensile resistance of the wires 20 of the tensile resistant light string is enhanced by the tensile resistant layer 21 in the premise without greatly increasing the cost and the total weight of the tensile resistant light string. This broadens applications of the tensile resistant light string.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A tensile resistant light string comprising:
multiple wires, each one of the wires comprising:
a tensile resistant layer;
a conductive layer; and
an insulating layer; and
multiple illuminating units electrically connected by the wire.

2. The tensile resistant light string as claimed in claim 1, wherein the insulating layer wrapping the conductive layer, and the conductive layer wrapping the tensile resistant layer.

3. The tensile resistant light string as claimed in claim 1, wherein the illuminating units are light emitting diodes or incandescent lamps.

4. The tensile resistant light string as claimed in claim 1, wherein the insulating layer is made of plastic,

5. The tensile resistant light string as claimed in claim 1, wherein the conductive layer is consisting of multiple metal lines, the metal lines are made of copper, aluminum, or iron.

6. The tensile resistant light string as claimed in claim 1, wherein the tensile resistant layer is consisting of at least one line, the at least one line is selected from the group consisting of a plastic line, a fiber line, cotton, a copper wire coated with a first isolation film, an aluminum wire coated with a second isolation film, or an ironic wire coated with a third isolation film, and the first isolation film, the second isolation film, and the third isolation film are made of plastic.

7. The tensile resistant light string as claimed in claim 1, wherein the tensile resistant light string comprises a plug, and the plug is electrically connected to the wires.
